(19) United States
(12) Patent Application Publication
(10) Pub. No.: US 2004/0189441 A1
(43) Pub. Date: Sep. 30, 2004

(54) Apparatus and methods for verification and authentication employing voluntary attributes, knowledge management and databases

(76) Inventor: Kosmas Stergiou, Phoenix, AZ (US)

Correspondence Address: MR. K. STERGIOU, 1720 E. THUNDERBIRD ROAD, #2092, PHOENIX, AZ, 85022, US

(21) Appl. No.: 10/394,679

(22) Filed: Mar. 24, 2003

(51) Int. Cl. H04Q 1/00; G05B 19/00

(52) U.S. Cl. 340/5.51; 713/200

(57) ABSTRACT

A method and apparatus for verifying the identity of an individually registered person employing knowledge management of a database repository of security information which includes Voluntary Attributes. The method includes the steps of collecting and registering assigned attribute information including personal security information such as name, date of birth, place or birth, along with voluntary attributes within a database; accessing a database containing information on registered persons; questioning the person based on the information; receiving and verifying an answer to the question; generating a score based on the answers; and confirming verification if the score is equal to or greater than a threshold.

### BACKGROUND OF THE INVENTION

The present invention relates to methods and apparatus for providing authentication and verification or identity to user access of services and/or facilities and, more particularly, to methods and apparatus for providing same employing database registration, question and answer selection and pairing, scoring techniques, assigned attributes, voluntary attributes, dynamic and static features.

In many instances, it is necessary to verify that an individual requesting a service or a facility is in fact the same person whom they claim to be. For example, such services may include banking services, telephone services, welfare services such as social security, or credit card services, while the facilities may be, for example, banks, government agencies, computer systems, or database systems. In such situations, users typically have to provide responses to questions through face-to-face speech, telephone, type or key in (e.g., on a keyboard) in order to verify their identity to send an order, make a request, obtain a service, perform a transaction or transmit a message.

Verification or authentication of a customer prior to obtaining access to such services or facilities typically relies essentially on the customer's knowledge of passwords or personal identification numbers (PINs) or by the customer interfacing with a remote operator who verifies the customer's knowledge of information such as name, address, social security number, city or date of birth, mother's maiden name, etc. Most of this information can be categorized as an “assigned attribute” of the customer as the customer generally had no ability to select his own date of birth, or place of birth, or mother's maiden name etc.

Conventional user verification techniques based upon assigned attributes present many drawbacks, in that these assigned attributes are often public information, or information which can be obtained easily, or information often known to a relative or friend of a person. Any perpetrator who is reasonably prepared to commit fraud usually finds it easy to obtain such personal information such as a social security number, mother's maiden name or date of birth of his intended target.

Other security measures for systems and facilities may require passwords, PINs or knowledge of bank account balances or of the last transaction/message provided during the previous service, such measures are also not reliable mainly because the user is usually unable to remember this information or because many users write the information down thus making the fraudulent perpetrator's job even easier. For instance, it is known that the many unwitting users actually write their PINs on the back of their ATM or smart card.

The shortcomings inherent with verification of Assigned Attributes have prompted an increasing interest in biometric security technology, i.e., verifying a person's identity by personal biological characteristics. Several biometric approaches are known, however, one disadvantage of biometric approaches is that they are expensive and cumbersome to implement. This is particularly true for security measures involved in remote transactions, such as internet-based or telephone-based transaction systems.

A superior verification technique which does not suffer many of the shortcomings inherent with assigned attribute or biometric verification makes use of voluntary attributes which are typically heavily influenced by the customers values, beliefs, resources and other aspects partially or wholly under the customers control. An example of a voluntary attribute is current phone number, favorite musical performer, favorite flower, name of pet.

### SUMMARY OF THE INVENTION

It is an object of the present invention to provide methods and apparatus for providing verification and authentication to services and/or facilities which preferably utilize random questioning of prior registration details. The registration details to comprise at least one of each of assigned attribute, and voluntary attribute, and none or more of biometric data.

In one aspect of the present invention, a method of verifying the identity of a person to one of a service and a facility comprises the steps of: (a) receiving first a claim to the identity of the person, the claim preferably comprising indicia of assigned attributes such as name, date of birth, place of birth etc; (b) accessing a database corresponding to the claimed identity, the database containing information attributable to the actual person whose identity has been claimed by the person; (c) querying the person with at least one random (but questions could be non-random) question based on the information contained in the accessed database; (d) receiving the answer of the person to the at least one random question; (e) verifying the accuracy of the answer against the information contained in the accessed database serving as the basis for the question; (f) generating a score corresponding to the accuracy of the decoded answer, and (g) comparing the score to a predetermined threshold value and if the score is one of substantially equivalent to and above the threshold value, then verifying the identity of the person to one of the service and the facility. If the score does not fall within the above preferred range, then verification of the identity may be denied to the person, the process may be repeated in order to obtain a new score, or a system provider may decide on another appropriate course of action.

In a first embodiment of this invention, the preliminary indicia may include identifying indicia, such as a name, address, customer number, etc., from which the identity claim may be made. However, in another embodiment, the identity claim may have already been made by the potential user keying in (or card swiping) a customer number or social security number, for example, in which case the indicia includes verifying indicia in order to aid in the verification of the identity claim. Also, the indicia may serve as additional information about the user which may serve as assigned and/or voluntary attribute parameters in building or updating the user's identity model.

It is an object of the invention to provide apparatus and methods which: use external information to build user models; extract information from the user's original documents to build identity models; extract information from a user to compare with existing identity models; drives the conversations to request specific information; understands the answers to these questions; compares the answers to information stored in a database; and accept or reject verification of a person's identity based on answers to the questions.

The resulting system is a combination of technology: knowledge management data capture, computer dialog interaction, identification and verification rules, and scoring techniques.

It is also to be appreciated that the methods and apparatus described herein use knowledge assigned to the user and knowledge established by the user, the combination thereof provides advantages much greater than the advantages respectively associated with each individual aspect. Such a formation of this unique identity profile which is capable of being accessible by a multitude of authorized enquiry agents has, prior to this invention, been unknown since the two concepts have previously been considered substantially mutually exclusive concepts.

The overall system provides a security level with an arbitrary level of security with prior identification and subsequent verification and authentication through a challenge-response knowledge management system. This global architecture has the advantage of being universal and adaptable to substantially any situation requiring verification or authentication. The complete transaction is monitored so that possible problems can be detected in using this data and flags are raised for further processing for action by the service provider.

A unique advantage of the overall system is that it can be used in situations where the inquiry agent and service agent operate within different businesses or may be located in different countries to each other, or that the inquiry agent may be located in a different country to the user being verified.

The advantage along with other objects and features of the present invention will become apparent from the following detailed description of illustrative embodiments thereof, which is to be read in connection with the accompanying drawings.

### BRIEF DESCRIPTION OF THE DRAWINGS

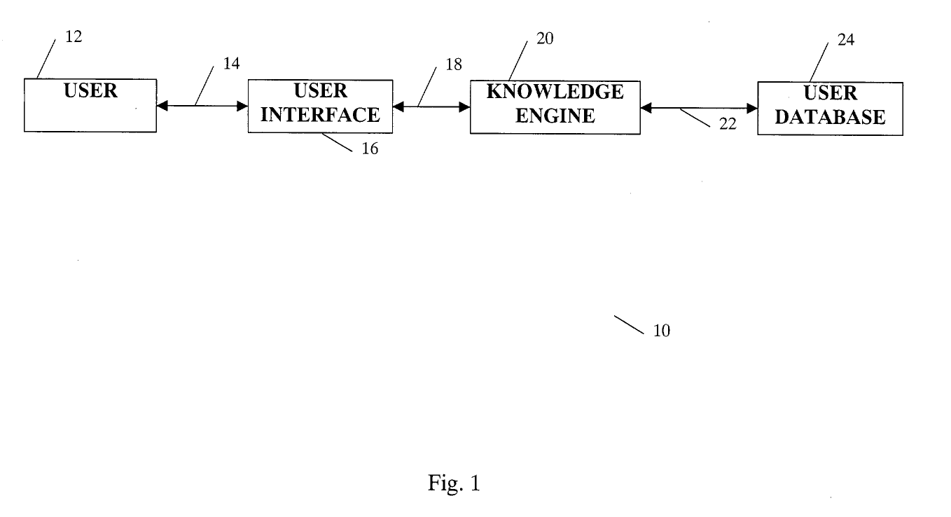

1. FIG. 1 is a flow chart/block diagram illustrating the functional interconnection between components of the invention; and

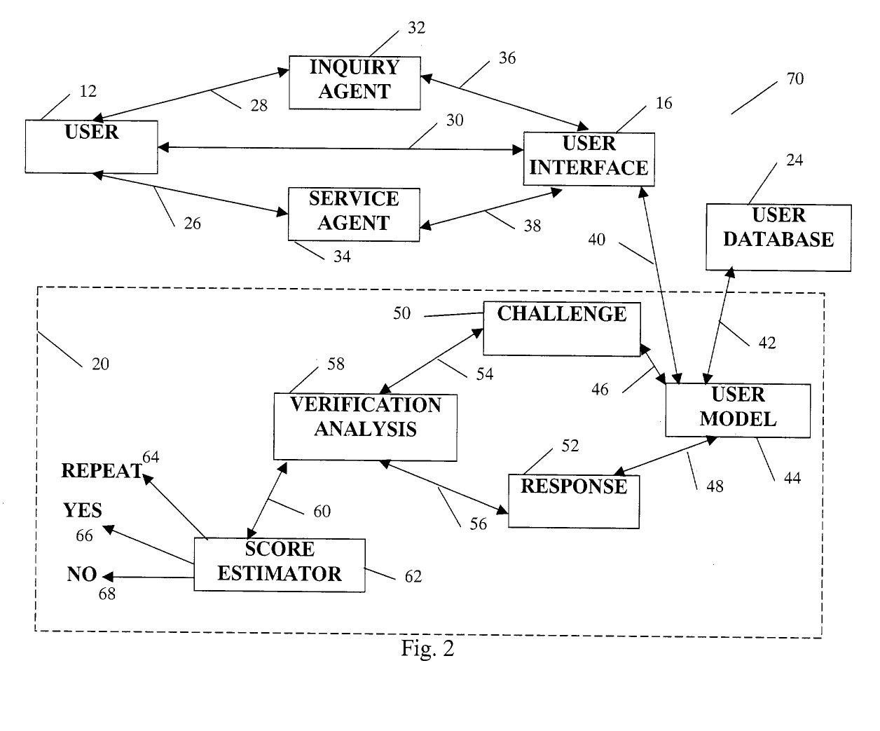

2. FIG. 2 is a flow chart/block diagram further illustrating components of the invention; and

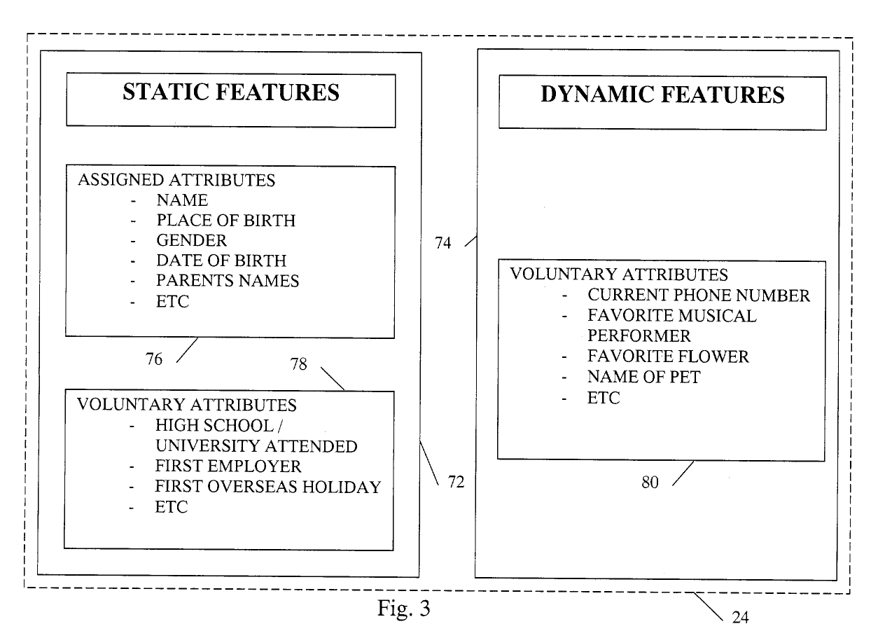

3. FIG. 3 is a block diagram illustrating a user database according to the invention; and

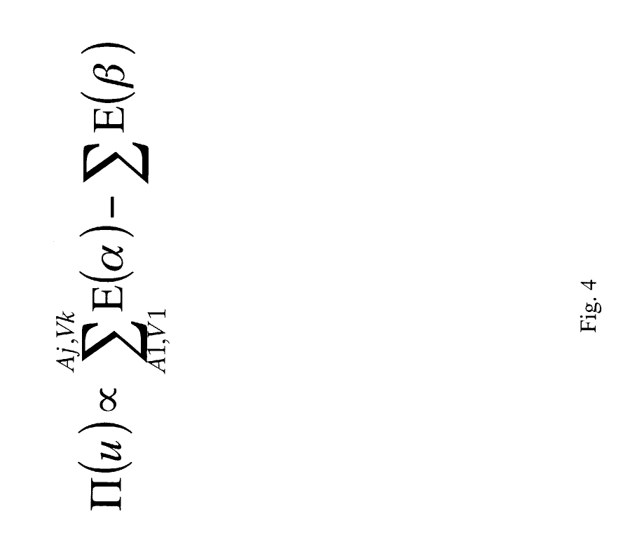

4. FIG. 4 is the calculation method illustrating the relationship between correct responses to challenge questions and overall confidence of verification.

### DETAILED DESCRIPTION OF PREFERRED EMBODIMENTS

Referring initially to FIG. 1, a flow chart/block diagram of the basic components of the invention is shown. The invention employs a unique combination of random questions, pre-registration, assigned attribute and voluntary attribute analysis to provide a significant improvement in verification and authorization to services and/or facilities (as discussed previously) requiring security measures. Specifically, a user (block 12) requesting access to a service/facility is subjected to a security system 10 employing a combination of random questions, pre-registration, assigned attribute and voluntary attribute analysis through a user interface (block 16) which provides functionality to a knowledge engine (block 20) via an iterative process (loop 14, 18) whereby the security system 10 utilizes process loop 22 to access user databases of information (block 24) to perform the verification/authentication of the user 12. These components and their specific interaction will be explained below in the context of the remaining figures.

It is to be understood that the components described herein in accordance with the invention may be implemented in hardware, software, or a combination thereof, although aspects of the method can also be performed by individuals trained to the underlying method of this invention. Preferably, the invention is implemented in software in the form of functional software modules on an appropriately programmed general purpose digital computer or computers. The actual location of the computer system implementing the invention is not critical to the invention; however, in an application where the user is requesting remote access via telephone, the invention or portions thereof may reside at the service/facility location or some location remote thereto. Further, the invention may be implemented in an internet environment in which case various portions of the invention may reside at the user's location and/or the service providers location, and that these locations may be separated by great distance or geographical boundaries.

Referring now to FIG. 2, one embodiment of the invention, illustrated via a flow chart/block diagram, is shown. It is to be understood that same or similar components illustrated throughout the figures are designated with the same reference numeral. A potential user 12 of the service/facility performs the following operation in cooperation with security system 10 in order to verify their identity to the service/facility. The user 12 accesses the user interface via link 30 or through an inquiry agent 32 or service agent 34 using the respective links of 28 and 26.

Whenever the user 12 is dealing with a service agent 34, the purpose of the dealing is to ultimately register the user 12 to the user database 24 or to modify or update existing information about the user within the user database. If the user is dealing with a service agent for the purpose of initial registration or if an existing registration is unsuitable for the verification of the user to the service agent then the user will need to prove their identity to the service agent through suitable multiple external proof documents which collectively verify the identity of the user to the required level of confidence. External proof documents can include but are not limited to driver license, passport, utility bill, bank statement, etc. The purpose of the external proof documents is to display a life history to a sufficient level which confirm the identity of the user who has provided the external proof documents to the service agent.

The interface between the user and the service agent is through link 26 which in turn the service agent would access the user interface 16 via link 38 to conduct the registration adjustments required by the user. It is to be appreciated that, while preferable, the user undertakes registration modification through a service agent, it is not mandatory that a service agent be used as a direct link 30 to the user interface would allow the user to self administer their registration updates.

Whenever the user 12 is dealing with an inquiry agent 32, the purpose of the dealing is for the inquiry agent to verify the identity of the user based upon the previous registration of the user to the user database 24 by a service agent 34. The user is in contact with the inquiry agent via link 28 which could be a telephone call, or internet connection or other appropriate communication media which one skilled in the art can devise. The inquiry agent utilizes the link 36 to the user interface 16 which accesses the user model 44 within the knowledge engine 20 to initially query the user database 24 via link 42 based upon static assigned attributes corresponding to the authentic user, such as name, social security number, date of birth etc. The initial query of the user database by the inquiry agent will then initiate a series of substantially simultaneous links 46 and 48 within the knowledge engine which corresponds to the authentic user for whom the user 12 will be verified.

The use of static information 72 within the user database 24 reflects information which normally changes infrequently, although it is not a requirement that static information never changes, examples of which can include the users name, date of birth, gender, etc. The use of dynamic information 74 within the user database 24 reflects information which may change on a frequent basis, although it is not a requirement that dynamic information must change. Examples of dynamic information can include the users address, name of current spouse, etc.

The initiation of user model 44 will result in a series of one or more challenge questions to be devised by the challenge block 50 and provided to the inquiry agent through link 46 and the previously established links which will be used by the inquiry agent to challenge the user in verifying their identity. By utilizing link 28, the inquiry agent will require the user 12 to provide a response to the challenge question which will be sent to the response block 52 through the already established links and link 48. The combined challenge question and response answer are provided for verification analysis (block 58) through the combined links 54 and 56, which performs an analysis to determine if the response question is correct for the challenge question based upon the user model 44 and the records contained within the user database 24. The verification analysis 58 interfaces to the score estimator 62 via link 60 for the purpose of the score estimator determining a statistical score which reflects the degree of confidence that the user 12 is in fact the verified user whom they claim to be.

It is to be appreciated that, while preferable, the name of the user is not mandatory in establishing the identity claim. The identity claim may be made from other information provided by the user, as explained herein. Also, the identity claim may be established by the user keying in or using a magnetic strip card to provide an identification number. The inquiry agent 32 then accesses a database (which is part of the user databases 24) via link 36 corresponding to the user (candidate) identified during the identification claim. As will be explained, the user database contains information specific to that particular user.

Next, utilizing the specific information from the identified user's database, the user model 44 selects a random question (or multiple random questions) from the user database for the user through challenge block 50. The user answers the random question(s) which is sent back to the user model 44 via link 36. It should be understood that links 36, 40, 42, 46 and 48 are preferably provided over a single communication path which may be hardwired (e.g. PSTN) or wireless (e.g. cellular). The separation of links is meant to illustrate functionality rather than physical implementation.

The user model 44 receives the user's answer and processes it through response 52. After decoding the answer, response 52 passes the answer for verification analysis 58 via link 56. Verification analysis 58 analyzes the answer to determine if the answer is correct, or not, in accordance with the information in the user's database. The result of the verification analysis 58 is sent to a score estimator 62 via link 60 where a partial score associated with the answer received from the user is generated. It should be understood that the lack of a “perfect” partial score does not necessarily indicate an incorrect answer from the user due to the fact that verification processes, such as employed by verification analysis 58, have acceptable response error rates associated therewith and, thus, while the actual answer is incorrect, the response answer may be close enough to satisfy the verification analysis such as for example when the response answer might be “Smith” and the actual answer expected might be “Mr Smith”.

Also, it is to be understood that some natural language understanding techniques may have recognition and/or understanding errors associated therewith such that, as a result, they do not correctly recognize and/or understand the answer provided by the user. Hence, in such cases, it is preferred that more than one random selected question be asked prior to making a decision to verify or deny verification to the user. Links 64, 66 and 68 from the score estimator 62 go back to the user interface 16 to indicate whether the answer was correct, not correct, or for some reason the answer was not understood and the answer should be repeated by the user 12. The question and answer process between the user 12 and the user interface 16 may continue for as many iterations as are desired to substantially ensure that the potential user is the user associated with the subject user database.

Based on a comparison of a combination of the partial scores (from the question/answer phase and verification provided by module 58) versus a predetermined threshold value, the user interface 16 decides whether or not to verify the user 12 to the service/facility. If the combined score is above or within an acceptable predetermined range of the threshold value, the user interface 16 may grant verification, else the server may decide to deny verification completely or merely repeat the process. Further, an inquiry agent 32 or service provider may decide to take other appropriate security actions.

Also, it is to be understood that because the components of the invention described herein are preferably implemented as software modules which may operate across different locations, the actual links shown in the figures may differ depending on the manner in which the invention is programmed.

It is to be appreciated that portions of the information in each database and the user models may be built by a pre-enrollment process. This may be accomplished in a variety of ways. The user may call into the system and, after making an identity claim, the system asks questions and uses the answers to build identification models and to improve the models throughout the entire interaction and during future interactions. Also, the user may provide some information in advance (pre-enrollment) through processes such as mailing back a completed informational form with similar questions as asked during enrollment over the phone. Then, an operator manually inputs the information specific to the user into the system.

Alternatively, the user may interact with a human operator who asks questions and then inputs answers to questions into the system. Still further, the user may complete a web (internet) question/answer form, or use e-mail, or answer questions from an IVR (Integrated Voice Response) system. Also, it is to be appreciated that the questions may preferably be relatively simple (e.g., what is your favorite color?) or more complex, depending on the application. The more difficult the question, the more likely it is that the actual user will only need to provide a smaller number of challenge/response question & answer pairs.

It is further to be understood that the system of the invention is capable of building more voluntary attribute questions, either by learning about the user or, after identifying the user, asking new questions and using the answers (which are transcribed and understood) as the expected answers to future random questions.

Accordingly, it is to be appreciated that the invention can build databases and models both automatically and manually. Automatic administration is performed by obtaining the name, address and whatever other identification tag that the service/facility desires and then invoking the user model to generate standard challenge questions to which the user would provide their responses which are used to verify the user prior to granting the user with access to perform self administration. Beyond the ability to self-administer users, the system of the invention provides the ability to automatically adapt, improve or modify its authentication processes. Still further, the automatic nature of the invention permits the building of a user profile for any purpose including the possibility of having other self-administering, self-validating and/or self-updating biometrics (e.g., face patterns for face recognition, iris recognition, etc.).

Thus, it is possible to combine biometrics (speech, voiceprint) in order to have self-enrolling biometrics. Self-validation is also provided such that whenever a score associated with the verification is poor, the present invention may be used to still admit the person but also to correct the models on the assumption that they are outdated.

It is to be appreciated that several variations to the above-described verification process are possible. For example, if an inquiry agent calls a user for the first time and the user has not been previously registered into the user database then the inquiry agent can elect to either proceed with verification of the users identity based upon other available information or may request the user to visit a service agent to undertake registration before the inquiry agent can fulfill their service activity.

Many ways for communicating the random questions to the user may be envisioned by one of ordinary skill in the art. For instance, if the user is attempting to access the service/facility through a web page, the questions may be presented in text form. If access is attempted over a telephone line, the questions may be asked via a voice synthesizer, a pre-recorded tape or a human operator. The actual method of asking the questions is not critical to the invention. Alternatively, it is to be appreciated that at least a portion of the answers provided by the potential user may be in a form other than text format, i.e., speech, keyed-in information, etc.

A further variation to the above-described system includes an embodiment wherein the inventive security system is implemented in a user's personal computer (at his home or office) to which the user seeks access. In such a scenario, a module substantially equivalent to the user interface module may a local database residing on the user's personal computer to validate voluntary attributes etc, and to decide whether or not to allow access. Specifically, a challenge/response and verification analysis module, such as those discussed above, may be implemented in the user's computer to perform the verification process discussed herein. One of ordinary skill in the art will appreciate further variations to the above-described embodiments given the inventive teachings disclosed herein.

Referring now to FIG. 3, a block diagram illustrating the possible types of information contained in a user database 24 is shown. The use of such voluntary and assigned attribute information, as previously explained, significantly improves the performance of the security measures described with respect to the invention. In addition, a variety of assigned attribute and voluntary attribute information may be included in the databases.

The information within the user database may be categorized as information exhibiting static features, i.e. information that does not change or changes slowly or periodically with time (block 72), and information exhibiting dynamic features, i.e., information that changes quickly or non-periodically with time (block 74). In other words, static information is a function of history and fact associated with the user and dynamic information is a function of the current attitude, lifestyle or values of the user.

Static information may be either assigned (block 76) or voluntary (block 78). Examples of static voluntary attribute information are university attended, first employer, first car, etc. Static assigned attribute information may be categorized as information extracted from the interaction between the user and the service agent, such as gender, nationality, name, date of birth, etc. On the other hand, dynamic information may include information regarding the user's values, attitudes, lifestyle, friends, etc. For instance, if the system of the invention is implemented on the user's computer, as previously mentioned, then the system may query the user who is seeking remote access thereto by asking which friend accompanied the user to a specific performance of a theater play on a particular day.

It is to be appreciated that the present invention can dynamically create new questions (from information provided in real-time), understand the respective answers and then use the information during the next transaction. Automatic enrollment of a new user may also be accomplished in a similar manner.

As previously explained, a user model is employed to estimate a probability of confidence in verification of a particular user's identity.

The user information that was described with respect to FIG. 3 may be advantageously used. to generate a model of users in order to enhance the verification process performed by module 58 (FIG. 2). It is to be understood that such a model estimates a probability of confidence for verification of a given user's identity from a known user's database.

In order to estimate the probability of confidence in verification of a user's identity from a known user's database, one can use one of the following procedures. First, one may introduce some assigned attribute parameters (features) that characterize users and denote them as A1,A2, A3, . . . A.sub.j.

Likewise, voluntary attribute parameters (features) may be introduced, i.e. age, time when a person attempts to access the service/facility, location from which the caller is calling, etc. and denote them as V1, V2, V3, . . . V.sub.k.

The overall confidence in the verification of the user identity is reflected in FIG. 4 by Π(u) which is directly proportional to a function of the difference between E(α) and E(β) for some users within the overall user database which is depicted in FIG. 4 following formula which is further defined below.

Now, one can estimate a score value for those challenge questions answered correctly E(α) by submitting those features comprising A.sub.j and V.sub.k to the user for a response. In addition a score value can be calculated E(β) which reflects a score of those challenge questions which were incorrectly answered.

The advantage of having a challenge response verification engine is apparent when the actual service is provided. The stream of challenges and responses fed to the verification engine and its natural language understanding module verifies that over the whole interaction, using combinations of public and non-public test data, that the verification still matches. Advantageously, problems can be flagged and depending on the service, the service may be interrupted or an operator may be called or a subsequent verification may be requested whereby the transaction is temporarily put on hold until the re-verification is accomplished.

Although the illustrative embodiments of the present invention have been described herein with reference to the accompanying drawings, it is to be understood that the invention is not limited to those precise embodiments, and that various other changes and modifications may be affected therein by one skilled in the art without departing from the scope and spirit of the invention.

What is claimed is:

1) A method of registering information into a database about the identity of a person based upon information that they provide and their selection of a multitude of questions to which they have provided truthful answers; the method comprising the steps of:
a) receiving a multitude of original documents from a person seeking to be registered;
b) reviewing these original documents to establish an opinion on their authenticity, and if so then proceeding;
c) reviewing these original documents to establish an opinion that they uniquely identify the person seeking to be registered, and if so then proceeding;
d) accessing or creating a database corresponding to the person seeking to be registered, the database to contain information attributable to the person seeking to be registered;
e) registering the person into the database along with a record of the provided original documents;
f) presenting a multitude of questions to the person from which they will elect all, none or a number of these questions to truthfully answer, the answers to which along with the questions are recorded in the database
g) allowing the person to devise any number of questions which are recorded into the database along with their truthful answers;
h) generating a score corresponding to the degree in which the recorded database details of the person are unique from the database details of other persons or other selected sources; and
i) comparing the score to a predetermined threshold value and if the score is one of substantially equivalent to and above the threshold value, then accepting the registration of the person to one of the service and the facility.

2) The method of claim 1, further comprising the step of one of denying registration to the person and repeating the process if the score is not substantially equivalent to and not above the threshold value.

3) The method of claim 1, wherein the original documents attributable to the person are not satisfactory and the method further comprising the steps of:
a) querying the user with a plurality of questions based on the information contained in the accessed database; and
b) requiring additional original documents from the person before confirming an opinion to proceed with registration.

4) The method of claim 1, wherein the original documents includes identifying documents.

5) The method of claim 1, wherein the original documents includes verifying documents.

6) The method of claim 1, wherein at least a portion of the information contained in the database is derived from original documents provided by the person prior to the selection of questions step.

7) The method of claim 1, wherein at least a portion of the information contained in the database is derived from answers to selected questions provided by the person.

8) The method of claim 1, wherein at least a portion of the information in the database has assigned attribute features.

9) The method of claim 1, wherein at least a portion of the information in the database has voluntary attribute features.

10) The method of claim 1, wherein the sub-step of electing the questions is performed by a knowledge management technique.

11) The method of claim 1, further comprising the step of requerying any question if the answer is not accepted during the registration step.

12) The method of claim 1, wherein one of the database and the model may be built through pre-enrollment of the person.

13) The method of claim 1, wherein one of the database and the model may be one of built and updated automatically during the method of verification or authentication of the person to one of the service and the facility.

14) The method of claim 1, wherein at least a portion of the at least one answer provided by the user may be in a form other than text.

15) The method of claim 1, wherein one of the database and the model may be simultaneously available to more than one of the service and the facility through a private and or public computer network.

16) Apparatus for controlling verification and authentication of a person to one of a service and a facility, the apparatus comprising:
a) means for accessing a database corresponding to the claimed identity of the person, the database containing information attributable to the person;
b) means for querying the person with at least one question based on the information contained in the accessed database;
c) means for verifying the accuracy of the answer against the information contained in the accessed database serving as the basis for the question;
d) means for generating a score corresponding to the accuracy of the answer and the uniqueness of the question and answer pair;
e) means for comparing the score to a predetermined threshold value and if the score is one of substantially equivalent to and above the threshold value, then permitting person access to one of the service and the facility; and
f) means for sharing access to the database from across more than one of the service and the facility.
